(19) United States
(12) Patent Application Publication
(10) Pub. No.: US 2014/0268427 A1
(43) Pub. Date: Sep. 18, 2014

(54) HEAD GIMBAL ASSEMBLY WITH DIAMOND-LIKE COATING (DLC) AT TONGUE/DIMPLE INTERFACE TO REDUCE FRICTION AND FRETTING WEAR

(71) Applicant: NHK SPRING CO., LTD, Yokohama (JP)

(72) Inventors: John HOGAN, Morgan Hill, CA (US); Ross CUYLER, Santa Cruz, CA (US); Edmund FANSLAU, San Jose, CA (US)

(73) Assignee: NHK SPRING CO., LTD, Yokohama (JP)

(21) Appl. No.: 14/185,464

(22) Filed: Feb. 20, 2014

Related U.S. Application Data
(60) Provisional application No. 61/787,388, filed on Mar. 15, 2013.

(51) Int. Cl. G11B 5/48

(52) U.S. Cl. CPC G11B 5/4826
USPC 360/245.4; 29/603.01

(57) ABSTRACT

A gimbal assembly of a single or dual stage actuator is provided with a layer of Diamond-Like Carbon (DLC) as a middle layer at a tongue/dimple interface where a dimple of a supporting loadbeam contacts a tongue on the gimbal assembly. Using the DLC at the tongue/dimple interface greatly reduces the amount of fretting wear particles formed during operation of the microactuator. The reduced wear at the dimple/gimbal interface may provide more stable dynamics over time. The DLC middle layer may be applied on the tongue, or on the tongue only at the tongue/dimple interface, or the DLC may be applied to the dimple.

### CROSS REFERENCE TO RELATED APPLICATION

The subject application claims the benefit of U.S. Provisional Application No. 61/787,388 filed Mar. 15, 2013, the contents of which are incorporated herein by reference.

### BACKGROUND

1. Field of the Invention

This invention relates to a gimbal assembly of a single or dual-stage actuator, and more specifically to a tongue/dimple interface which applies a diamond-like carbon layer to either the dimple or the tongue of the gimbal at the tongue/dimple interface as a middle layer. This middle layer of diamond-like carbon serves to reduce friction and fretting wear.

2. Description of the Related Art

In a hard disk drive assembly, a magnetic recording Head Gimbal Assembly (HGA) provides the freedom for the recording head to move over the contours of the disk and accommodate disk drive assembly tolerances. This gimbal assembly of the read/write head permits the head to move from track to track over a platter on which data is stored. The recording head, made of silicon, has an etched air bearing surface to help the recording head “fly” over the recording disk and maintain an appropriate distance from the disk. The air bearing pivots on a formed dimple in the metal suspension component of the HGA. Because of continuous motion and variation in the drive assembly, the gimbal interface between the dimple and the tongue is in constant relative motion. To further complicate the motion of this interface a second or dual stage actuation may also be introduced. The dual stage actuator provides additional finer actuation, or movement. A finer level of movement may be achieved at a tip of the head, or slider, usually as a result of a piezoelectric transducer (PZT) mechanism. Activation of the PZT is translated into movement of the slider, and this permits finer movement across tracks on the platter. This allows tracks to be spaced closer together, thus enabling more data to be stored on a platter.

A hard disk drive magnetic recording head gimbal assembly has the magnetic recording head, or slider, suspended over the recording disk media material by a suspension containing a gimbal for the slider. Conventional gimbals use a stainless steel foil formed into a dimple that contacts a flat stainless steel tongue. The slider body is rigidly bonded to the tongue and the slider, and then is able to rotate, or “gimbal,” about the dimple surface at a tongue/dimple interface. Both the tongue and dimple are often made of stainless steel which wear together during suspension assembly, head gimbal assembly, head stack assembly, disk drive assembly and disk drive operation. When the dimple and tongue wear together, wear particles are generated that may be harmful to the disk drive. The wear particles are generated by what is known as fretting or tribo chemical corrosion (tribocorrosion), the combined effects of wear and corrosion. In the case of the contact between the tongue and dimple, the tribocorrosion is due to the exposure of iron to oxygen, and, along with fretting wear, results in iron oxide wear particles which are typically a hard, flaky substance. These wear particles may interfere with the recording device (for example, the wear particles may get between the recording head and the recording disk or scratch the recording disk. The dimple/gimbal interface may also wear over time thus changing the dynamics of the interface. Finally, increased friction will prevent the air bearing from fully controlling how the recording head flies over the disk. A large amount of wear particles is believed to be a cause of degraded performance of the hard drive and even complete hard drive failure.

### SUMMARY

Accordingly, it is an object of the present invention to provide an HGA that minimizes the amount of wear particles, thereby preventing degraded performance and helping to ensure long term reliability of the hard drive.

According to an exemplary embodiment of the present invention, a gimbal assembly of a single or dual-stage actuator is provided with a diamond-like carbon layer at a tongue/dimple interface where a dimple of a supporting loadbeam contacts a tongue on the gimbal assembly. This diamond-like carbon layer serves as a middle layer to reduce friction and wear, helping to ensure long term reliability. In one exemplary embodiment of the invention, a gimbal assembly comprises: a tongue with a first side and a second side; a tongue/dimple interface on the second side of the tongue, at which a dimple of a loadbeam is movably connected; a thin layer of diamond-like carbon is formed between the dimple and the tongue at the tongue/dimple interface in order to reduce friction and fretting wear.

The diamond-like carbon layer may be between approximately 10 and 500 nm in thickness, and preferably approximately 10 nm.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a top-down view of a head gimbal assembly (HGA), including a tongue, loadbeam and tongue/dimple interface, according to one embodiment of the invention; a single stage actuator configuration;

FIG. 2 illustrates a bottom-up view of the gimbal assembly of FIG. 1, further illustrating a dimple positioned on the loadbeam, according to one embodiment of the invention; a single stage actuator configuration;

FIG. 3A illustrates a lateral view of the HGA depicting the location of a slider and a piezoelectric transducer (PZT), according to one embodiment of the invention; in a dual stage actuator configuration;

FIG. 3B illustrates a lateral view of the HGA connected with the loadbeam depicting how the dimple contactingly interacts with the tongue at the tongue/dimple interface, according to one embodiment of the invention; in a dual stage actuator configuration;

FIG. 4A illustrates a top perspective view of the HGA, according to one embodiment of the invention; in a dual stage actuator configuration;

FIG. 4B illustrates a bottom perspective view of the HGA with the PZT and slider positioned thereon, according to one embodiment of the invention; in a dual stage actuator configuration;

FIG. 5 is an illustration of a stress diagram showing the degree of movement of the structures of the HGA as the HGA rotates about the tongue/dimple interface, according to one embodiment of the invention; in a dual stage actuator configuration;

FIG. 6 illustrates an exploded perspective view of the HGA depicting the layers of the tongue, and specifically a Diamond-Like Carbon (DLC) layer provided on the tongue at the tongue/dimple interface, according to one embodiment of the invention; in a single stage actuator configuration;

FIG. 7 is a block diagram which illustrates a method of fabricating the HGA assembly, according to one embodiment of the invention;

FIGS. 8(a) and 8(b) are representative views showing the formation of the dimple;

FIG. 9 is a graph showing Friction of Coefficient versus Thickness of the DLC Coating (nm) for different types of dimples according to exemplary embodiments.

In the following detailed description, reference will be made to the accompanying drawings. The aforementioned accompanying drawings show by way of illustration, and not by way of limitation, specific embodiments and implementations consistent with principles of the present invention.

### DETAILED DESCRIPTION OF THE PREFERRED EMBODIMENTS

The embodiments and implementations described above are presented in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense.

A remotely-driven rotary head dual stage actuator suspension, such as a dual stage microactuator suspension and more specifically a head gimbal assembly (HGA), is described herein. The HGA includes a tongue which interacts with a dimple of a loadbeam at a tongue/dimple interface. A diamond-like carbon (DLC) layer is provided as a middle layer on the tongue at the tongue/dimple interface in order to reduce friction and the amount of fretting wear and tribocorrosion, thereby reducing the amount of wear particles that lead to degradation and failure of the hard disk drive.

FIG. 1 illustrates a top-down view of a first side of one embodiment of a head gimbal assembly (HGA) 100, including a tongue 102 which interacts with a dimple 114 (see FIG. 2) of a loadbeam 104 at a tongue/dimple interface 106. An outer ring 108 (see FIG. 1) covers wire traces 110 that are run from the tip of the read/write head on a slider (see FIG. 3B) back to a base portion 112 of the HGA 100.

FIG. 2 illustrates a bottom-up view of a second side of one embodiment of the loadbeam 104 with a dimple 114 positioned below the HGA 100. The dimple 114 is positioned directly underneath the tongue 102 and interacts with the tongue 102 at the tongue/dimple interface illustrated in FIG. 1.

FIG. 3A illustrates a side view of the HGA 100 which also illustrates the location of the slider 116 and a piezoelectric transducer (PZT) 118 which drives the movement of the HGA 100. FIG. 3B illustrates the interaction between the HGA 100 and the loadbeam 104, specifically illustrating where the tongue 102 and dimple 114 would contact with each other at the tongue/dimple interface 106. The HGA 100 is positioned immediately below the loadbeam 104.

FIG. 4A is an illustration of a perspective view of an upper side of a head gimbal assembly 100, illustrating the tongue 102, outer ring 108 and the base portion 112. while FIG. 4B is an illustration of a perspective view of the opposite, lower side of the head gimbal assembly 100 where the slider 116 and PZT 118 are connected with the HGA 100. Solders (not shown) are provided to electrically connect the slider 116 and the wires 110.

FIG. 5 is a stress diagram of the HGA 100 showing different shades from dark to light which correspond to the degree of movement of the various structures of the HGA 100 during the movement of the HGA 100. A semi-circular arrow A represents the angle of movement of the HGA 100, and the arrow “A” illustrates how the tongue 102 rotates about a central portion of the tongue. A dark circle 120 at the central portion corresponds to the tongue/dimple interface 106, and illustrates the movement which the tongue and dimple are subjected to during operation of the microactuator.

FIG. 6 is an exploded view of the HGA 100 and loadbeam 104 which illustrates the structure of the multiple layers of the HGA 100 and the position of the loadbeam 104 and dimple 114 with respect to the HGA 100. The exploded view of the HGA is illustrated in an upside-down position simply for clarity. The tongue is part of a larger component of the HGA known as the flexure, and the flexure includes gold formed by, for example, gold plating on a set of electrical copper traces to prevent corrosion. In one embodiment, the HGA layers include a stainless steel layer 122, an insulation layer 124 such as polyimide, a copper circuit layer 126 which is etched into copper circuits, and a polyimide cover plate 128. A gold layer 130 is provided over copper circuits in the circuit layer 126 to protect the copper circuits from corrosion.

In the embodiment illustrated herein, a diamond-like carbon layer 132 is provided as a middle layer for placement on the tongue 102 at the tongue/dimple interface 106. The diamond-like carbon layer 132 may be implemented on the stainless steel layer 122 as an “island” of diamond-like carbon in the middle of the tongue, with a copper base and a polymer cover coat.

In one embodiment, the stainless steel layer may be between approximately 10 to 25 micrometers (μm), and is typically approximately 18 μm. The polyimide insulation layer 124 may be approximately 10 μm, the copper circuit layer 126 between approximately 5 to 12 μm and the polyimide cover plate 128 approximately 4 μm. The diamond-like carbon layer 130 may be between approximately 10 nm to 500 nm, with a preferable thickness of approximately 10 nm. As described in U.S. Appln. No. 61/787,388, carbon coated gimbals were found to exhibit a lower friction coefficient and better wear characteristics than gimbals without a carbon overcoat. Moreover, a carbon overcoat thickness of 10 nm on a stainless steel gimbal was found to give the lowest coefficient of friction and showed a smaller wear scar than other gimbal types with a greater carbon overcoat thickness.

A method of fabricating the gimbal assembly with the diamond-like carbon as a middle layer at the tongue/dimple interface is illustrated by the block diagram in FIG. 7. In a first step S102, three laminate layers of stainless steel (SST), polyimide (Pl) and copper (Cu) are received and loaded. Next, a resist is applied for etching the SST and Cu layers in step S104. In step S106, Cu etching is performed, and in step S108, the resist is removed. In step S110, a resist for chemical polyimide etching is applied, and then removed in step S112. In step S114, the diamond-like carbon layer 130 is applied through, for example, sputtering using a coating machine as is well known to those skilled in the art.

In one embodiment, a nickel sub-plate may be applied to the stainless steel layer prior to applying the layer of diamond-like carbon. Finally, in step S116, the cover plate layer 128 is applied. According to this exemplary method, a copper pad of approximately 0.5 millimeters in diameter is provided underneath the layer of diamond-like carbon at the tongue/dimple interface which is created during the copper etching in step S106.

In the embodiment discussed above, the layer of diamond like carbon is applied to the tongue 102 using conventional sputtering techniques well known to those skilled in the art. This diamond-like carbon layer could be applied to the entire tongue, which from a manufacturing standpoint, might be easiest, or using masks, applied only to a portion of the tongue at the tongue/dimple interface.

In an alternate embodiment, the dimple 114 could be applied with the layer of diamond-like carbon instead of the tongue 102, again using conventional sputtering techniques. The use of a diamond-like carbon layer at the tongue/dimple interface avoids fretting wear and tribo chemical corrosion that would otherwise form the hard, flaky iron oxide wear particles and cause disk drive contamination.

As mentioned, experimental testing was conducted in connection with friction coefficient and fretting wear evaluation. The experimental set-up for examining the dimple/gimbal interface during fretting wear involved placing the gimbal on a linear slider connected to a piezoelectric actuator. A voltage was applied to the piezoelectric actuator causing horizontal movement of the gimbal relative to the dimple. A preload force of approximately 20 milli-Newtons was applied onto the gimbal. A Futek load cell was attached to the suspension to measure the frictional force. A 1-D Polytec Laser Doppler Vibrometer (LDV) was used to measure the velocity and displacement of the gimbal. In addition, a Polytec Fiber LDV was used to measure the displacement of the suspension, which was assumed to be equal to the displacement of the dimple. The difference between the two LDV measurements gives the relative displacement between the dimple and gimbal. The data was collected and analyzed in real-time using a data acquisition board and LabVIEW software provided by National Instruments.

Three different dimple designs were tested: (i) un-coined dimple, (ii) coined dimple and (iii) laser-polished dimple. FIGS. 8(a) and 8(b) show the steps for manufacturing un-coined and coined dimples, respectively. As is shown in FIG. 8(a), during manufacturing of un-coined dimples, the work piece is first positioned onto a flat base before being pushed into a cavity by a punch, forming the dimple. In manufacturing a coined dimple, a coining die is used (FIG. 8(b))). Laser-polished dimples are manufactured using a laser after coining to reduce the surface roughness of the dimple. A summary of typical roughness data of laser polished dimples is provided in U.S. Appln. No. 61/787,388.

All gimbals tested were made from stainless steel (SST). As indicated in Table 1 below, Gimbals A, B, C, and D were coated with a diamond-like carbon (DLC) overcoat of 10, 50, 150 and 500 nm thickness, respectively. In addition, uncoated stainless steel gimbals were studied with and without lubricant (per-fluorinated polyether).

TABLE 1
Gimbal types used in the experiment

| | Diamond-like Carbon |
|---|---|
| Gimbal types | thickness |
| Gimbal A | 10 nm |
| Gimbal B | 50 nm |
| Gimbal C | 150 nm |
| Gimbal D | 500 nm |
| SST gimbal without | N/A |
| lubricant | |
| SST gimbal with | N/A |
| lubricant | |

### Experimental Procedure:

In each experiment, 52,000 reciprocating fretting wear cycles were performed. In order to reduce the time needed for each test, the total number of cycles was divided into three parts. In the first part, 6,500 cycles were performed at a low frequency of 2 Hz. In the second part, 42,300 cycles were conducted at 20 Hz, while in the third part 3,200 cycles were performed at 2 Hz, giving a total number of 52,000 cycles. A triangular waveform with two-volt amplitude was used as the input signal to the piezoelectric actuator. This resulted in a horizontal displacement (stroke) of 10 micro-meters. A pre-load of 20 mN was used in all tests.

A detailed discussion of all of the testing is set forth in U.S. Appln. No. 61/787,388. However, a summary of the various tests is set forth below:

### Friction Tests for Un-Coined Dimple Gimbals

The friction coefficient for an un-coined dimple gimbal A, with the thinnest carbon overcoat of 10 nm, was found to be lower than the friction coefficient of gimbal B or gimbal C. The friction coefficient of gimbal D was lower than that of gimbal B and C, but higher than A. The friction coefficient for the un-lubricated stainless steel gimbal, without carbon overcoat, was highest, while the friction coefficient of the lubricated SST gimbal falls between that of gimbal A and that of the un-lubricated gimbal. Thus, the un-coined gimbal A (10 nm DLC thickness) exhibited the lowest friction coefficient amongst all gimbals tested.

### Wear Scar Testing of Un-Coined Dimples

Testing of wear scars was conducted for un-coined dimples after 52,000 fretting wear cycles against gimbal A, gimbal B, gimbal C, and gimbal D. In addition, testing of dimple wear scars for an un-lubricated stainless steel (SST) gimbal and a lubricated SST gimbal were also conducted. The testing revealed that wear scars of the un-coined dimple against gimbal A (thinnest carbon overcoat) was smaller than the wear scars for gimbal B and C, respectively. The wear scar of the un-coined dimple versus gimbal D was of the same order of magnitude as that of gimbal A. The largest wear scar was obtained for the un-lubricated SST dimple, while the smallest wear scar was seen to occur for the lubricated SST gimbal.

### Friction Tests for Coined Dimple Gimbals

Friction coefficient tests were conducted for a coined dimple as a function of wear cycles against gimbal A (10 nm DLC thickness), gimbal B (50 nm DLC thickness), gimbal C (250 nm DLC thickness), gimbal D (500 nm DLC thickness), and a lubricated and an un-lubricated stainless steel gimbal. The testing revealed that the friction coefficient of gimbal A, with the thinnest carbon overcoat, was lower than that of gimbal B or gimbal C. The friction coefficient of gimbal D was lower than that of gimbal B and C, but higher than that of gimbal A. The friction coefficient for the un-lubricated stainless steel was highest, while the friction coefficient of the lubricated SST gimbal falls between the other tests. This behavior was found to be very similar to that of the un-coined dimple.

### Wear Scar Testing of Coined Dimples

Testing was conducted for wear scars of coined dimples after 52,000 fretting wear cycles against gimbal A, gimbal B, gimbal C and gimbal D. In addition, wear scars for typical un-lubricated stainless steel (SST) gimbals and lubricated SST gimbals were tested. The testing revealed that the wear scar of the coined dimple against gimbal A, with the thinnest carbon overcoat, was again smaller than the wear scars for gimbal B and C. The wear scar of the coined dimple versus gimbal D was similar to that of gimbal A. The largest wear scar obtained was for the un-lubricated SST dimple, while the smallest wear scar was obtained for the lubricated SST gimbal. The trend of the wear scar of the coined dimple versus the various dimple types is very similar to that observed for the un-coined dimple.

### Friction Coefficient for Laser-Polished Dimple and Different Gimbal Types

Friction coefficient testing was also conducted for a laser-polished dimple as a function of wear cycles against gimbal A (10 nm DLC thickness), gimbal B (50 nm DLC thickness), gimbal C (250 nm DLC thickness) and gimbal D (500 nm DLC thickness). In addition, the friction coefficient testing was conducted for lubricated and un-lubricated stainless steel gimbals, respectively. Similar to the results from the un-coined and coined tests, the testing revealed that the friction coefficient of gimbal A, with the thinnest carbon overcoat of 10 nm, was lower than that of gimbal B or gimbal C, with 50 and 150 nm carbon overcoat thickness. The friction coefficient of gimbal D was lower than that of gimbal B and C, but higher than that of gimbal A. The friction coefficient for the un-lubricated stainless steel was highest, while the friction coefficient of the lubricated SST gimbal falls between the friction coefficient of gimbal C and gimbal D. This behavior is very similar to that observed for the un-coined and coined dimples.

Wear Scars of Typical Laser-Polished Dimples after 52,000 Fretting Wear Cycles for Different Gimbal Types

Testing of wear scars for typical laser-polished dimples versus different gimbal types was also conducted. Similar to the coined and un-coined case, the testing showed that the smallest wear scars for the laser-polished dimples are observed for gimbal A and the lubricated stainless steel (SST) gimbal. The wear scar of the laser polished dimple against gimbals C and D was larger than the wear scar for gimbal A or the lubricated SST gimbals. The wear scar of the un-lubricated stainless steel gimbal against the laser-polished dimple was larger than that of all other wear scars.

FIG. 9 is a graph plotting mean friction coefficient vs. Diamond-Like Carbon (DLC) thickness. In FIG. 9, the friction coefficients of un-coined dimples, coined dimples, and laser polished dimples are plotted as a function of the thickness of the carbon overcoat. FIG. 9 demonstrates that the friction coefficient first increases with increasing coating thickness, reaches a maximum, and then decreases as the carbon overcoat increases to a thickness of 500 nm. Clearly, the gimbal with the thinnest carbon overcoat shows the lowest friction coefficient, regardless of the dimple type used.

A similar behavior was also observed for the wear scar as a function of carbon overcoat thickness, i.e., the wear scar was smallest for the 10 nm overcoat thickness, increases with increasing carbon overcoat thickness and decreases as the carbon overcoat increases to a value of 500 nm thickness.

Based on the above-described testing, the gimbal with the thinnest carbon coating (gimbal A) has the best tribological performance. This result is surprising and somewhat counter-intuitive, since one would have expected a steady improvement in the friction and wear characteristics of the interface with an increase in the carbon overcoat thickness. The result may be related to variations in the carbon deposition process with increasing carbon thickness, but otherwise the testing results of the carbon characteristics of the 50, 150, 250 and 500 nm thick carbon layers are both surprising and somewhat counter-intuitive.

The friction and wear characteristics of the dimple/gimbal interface were also studied keeping the carbon overcoat thickness constant for all three dimple types examined.

Testing was conducted to examine the friction coefficient for the un-coined, coined and laser-polished dimple as a function of fretting wear cycles for gimbal A, i.e., coated with 10 nm of diamond-like carbon. The testing demonstrated that for the first 6,500 cycles, the coined dimple had the lowest friction coefficient, followed by the un-coined and laser-polished dimples. However, the differences among the three dimple types were small. The un-coined and coined dimples were observed to have lower values than the laser-polished dimple. The differences, however, were small. Wear scar testing was also conducted demonstrating that the wear scars of the coined and laser-polished dimples were smaller compared to the un-coined dimple. The wear scar of the coined and laser-polished dimple was of comparable size.

Similar friction coefficient testing was conducted of un-coined, coined, and laser-polished dimples during 52,000 cycles against gimbal B (50 nm DLC thickness). The testing showed that the friction coefficient for the first 6500 cycles of the coined dimple was lower than that of the coined or laser-polished dimple. However, the un-coined dimple had a higher friction coefficient than laser-polished and coined dimples during the last 3,200 cycles of the experiment. The coined dimple showed the lowest friction coefficient in the final 3,200 cycles. Wear Scar testing of un-coined, coined, and laser-polished dimples were also conducted to show fretting wear on gimbal B. When the three dimple types were tested with gimbal B (50 nm DLC thickness), the results showed large wear scars after 52,000 cycles for all three dimple types. This result is in agreement with the previous conclusion that the friction and wear performance of gimbal B is not as good as that of gimbal A.

Friction coefficient testing was conducted for un-coined, coined and laser polished dimples with gimbal C (150 nm DLC thickness). The testing showed that the coined dimple has the lowest friction values, followed by the laser-polished and un-coined dimples. However, the differences were small. It was found that the coined dimple again has the lowest friction coefficient. The laser-polished and un-coined dimples have higher friction coefficients than the coined dimple. Wear scar testing was also conducted for coined, coined, and laser-polished dimples against gimbal C (150 nm DLC thickness). The testing showed that after 52,000 fretting wear cycles, the wear scars on the coined and laser-polished dimples were smaller compared to those of the un-coined dimple. The coined and laser-polished dimples showed less wear and, therefore, produce fewer wear particles than the un-coined dimple.

Friction coefficient testing was also conducted for un-coined, coined, and laser-polished dimples with gimbal D (500 nm DLC thickness). Results were obtained from the first 6,500 cycles, and from the last 3200 cycles. All three dimples are observed to show very similar friction coefficient values. This trend does not change even for the last 3,200 cycles. Thus, the tribological performance of the three different dimple types is very similar for gimbal D. In addition, wear scar testing was conducted for un-coined, coined, and laser-polished dimples versus gimbal D (500 nm DLC thickness). After 52,000 cycles of fretting motion, the coined dimple was observed to have the smallest wear scar when compared to the other two dimples. The wear scar on the un-coined dimple was found to be larger than that of the coined dimple, while the laser-polished dimple shows a wear scar that is both larger and darker than the wear scar on the coined dimple.

Friction coefficient testing was also conducted for un-coined, coined, and laser-polished dimples versus fretting wear cycles for un-lubricated stainless steel (SST) gimbals. This testing showed that the friction coefficient values of all three dimple designs were similar. The friction values were very high when compared to the results with other gimbal types, and the high friction coefficient values were maintained throughout the entire fretting wear experiments. In addition, wear scar testing was conducted for un-coined, coined, and laser-polished dimples after 52,000 fretting wear cycles for un-lubricated stainless steel gimbals. The wear scars for the three types of dimples were found to be similar in size. However, the wear scars are much larger when compared to the other types of dimples tested and it is apparent that DLC coated gimbals have a smaller wear scar than un-coated gimbals. The testing reveals that carbon-coated gimbals have less wear and generate fewer wear particles than un-coated gimbals during 52,000 cycles of fretting wear.

Friction coefficient testing was also conducted for un-coined, coined, and laser-polished dimples against lubricated stainless steel (SST) gimbals. The testing showed that the friction coefficients of the three types of dimples were similar during the first 6,500 cycles. The testing also showed that the friction coefficients for the different dimple designs were also similar for lubricated gimbals. In addition, wear scar testing was conducted in connection with the three dimple designs investigated for lubricated stainless steel gimbals. The testing showed that the size of all wear scars was similar. However, the size of the wear scars was much smaller when compared to un-lubricated wear scars, indicating that the use of a lubricant improves the tribological performance of the dimple/gimbal interface.

Comparing un-coined, coined, and laser-polished dimples, the testing showed that the coined dimple has a lower friction coefficient and a smaller wear scar compared to the un-coined and laser-polished cases. Furthermore, the friction coefficients of gimbal A (10 nm DLC thickness) and gimbal D (500 nm DLC thickness) were smaller than those of the other gimbal types tested.

In order to investigate the effect of lubricant on the friction and wear characteristics of the dimple/gimbal interface with DLC coating, gimbal A and gimbal B were tested against un-coined dimples.

For both types of gimbals, two tests were performed. The first test was a fretting wear test without lubricant, and the second test was a fretting wear test with lubricant.

The testing showed that the friction coefficients of both gimbal A without lubricant and gimbal A with lubricant are similar during the first 6,500 cycles. During the last 3,200 cycles, gimbal A without lubricant showed a slightly lower friction coefficient than gimbal A with lubricant. However, the testing also showed that the wear scar of gimbal A with lubricant was much smaller than the wear scar for gimbal A without lubricant. This, clearly, shows that the friction coefficient is only one parameter in describing the tribological characteristics of the dimple/gimbal interface, i.e., wear is of equal or larger importance in studying the dimple/gimbal interface than friction.

The fretting wear testing also showed that the friction coefficient of gimbal B without lubricant is higher than the friction coefficient of gimbal B with lubricant. In the case of gimbal B with lubricant, the wear scar of the un-coined dimple was found to be much smaller than the wear scar for gimbal B without lubricant. Clearly, lubrication of the dimple/gimbal interface can be effective in modifying the friction and wear characteristics of the dimple/gimbal interface.

Since the friction coefficient at the dimple/gimbal interface is an important parameter, the mean friction coefficient was calculated after 52000 fretting wear cycles and this value was compared for the different cases tested. In Tables 2(a) and 2(b) the values of the mean friction coefficient and the standard deviation of the mean friction coefficient are summarized.

TABLE 2
Mean and standard deviation of friction coefficient.

| | | | | | |
|---|---|---|---|---|---|
| | | | | | SST |
| Gimbal | Gimbal | Gimbal | Gimbal | | Gimbal |
| A | B | C | D | | With |
| (10 nm | (50 nm | (150 nm | (500 nm | SST | lubri- |
| DLC) | DLC) | DLC) | DLC) | Gimbal | cant |

(a) Mean friction coefficient

| | | | | | | |
|---|---|---|---|---|---|---|
| Un- | 0.11 | 0.27 | 0.30 | 0.15 | 0.36 | 0.17 |
| coined | | | | | | |
| Dimple | | | | | | |
| Coined | 0.09 | 0.20 | 0.26 | 0.16 | 0.33 | 0.16 |
| Dimple | | | | | | |
| Laser- | 0.12 | 0.33 | 0.28 | 0.15 | 0.34 | 0.18 |
| polished | | | | | | |
| Dimple | | | | | | |

(b) Standard deviation of friction coefficient

| | | | | | | |
|---|---|---|---|---|---|---|
| Un- | 0.02 | 0.09 | 0.05 | 0.01 | 0.03 | 0.03 |
| coined | | | | | | |
| Dimple | | | | | | |
| Coined | 0.01 | 0.05 | 0.03 | 0.01 | 0.02 | 0.02 |
| Dimple | | | | | | |
| Laser- | 0.02 | 0.03 | 0.04 | 0.004 | 0.02 | 0.04 |
| polished | | | | | | |
| Dimple | | | | | | |

From Table 2, it can be observed that the coined dimple with gimbal A (10 nm DLC thickness) shows the lowest mean friction coefficient of 0.09, followed by a friction coefficient of 0.11 for the un-coined dimple with gimbal A. The laser-polished dimple with gimbal D (500 nm DLC thickness) and the un-coined dimple with gimbal D show the two smallest standard deviation of the friction coefficients measured. The coined dimple with gimbal A (10 nm DLC thickness) shows the third smallest standard deviation of all friction coefficients. The mean friction coefficient of the laser-polished dimple with gimbal D (500 nm DLC thickness) and the un-coined dimple with gimbal D are higher compared to the coined dimple with gimbal A. Therefore, Table 2 shows that the coined dimple with gimbal A has the best frictional performance among all the dimple/gimbal combinations investigated.

The testing described above indicates that gimbal A with a 10 nm DLC thickness showed the smallest amount of wear scars. Additional testing, however, has shown that gimbal D, i.e., the gimbal with a carbon overcoat of 500 nm DLC thickness produced the least amount of wear particles. The amount of wear particles seemed to depend on the hardness of the gimbal, with the softest gimbal generating the least amount of wear particle. The testing showed that the thicker the layer of DLC, the softer the gimbal and the lesser amount of wear particles. The hardness testing showed that gimbal D with the thickest DLC was the softest of the gimbals tested, followed by gimbal C with DLC thickness of 150 nm, then gimbal B with DLC thickness of 50 nm, and then finally gimbal A with DLC thickness of 10 nm, being the hardest of the tested gimbals.

From the experimental results and testing conducted, it is concluded:
1) Carbon coated gimbals are found to exhibit a lower friction coefficient and better wear characteristics than gimbals without carbon overcoat.
2) A carbon overcoat thickness of 10 nm on a stainless steel gimbal was found to give the lowest coefficient of friction.
3) Some of the testing showed a smaller wear scar for the gimbal with DLC of 10 nm than other gimbal types with greater carbon overcoat thickness, but other testing showed that the gimbal with DLC of 500 nm exhibited the least amount of wear particles.
4) Coined dimples mated with carbon over coated gimbal A (10 nm DLC thickness) were found to be the optimum dimple/gimbal material combination with respect to friction and wear.
5) For both gimbal A and gimbal B, the use of a lubricant was found to decrease the wear scar and the generation of wear particles.
6) It is surprising and somewhat counterintuitive that at least the friction characteristics do not improve with an increase in the carbon overcoat thickness above 10 nm.

What is claimed is:

1. A gimbal assembly of a actuator comprising:
a tongue with a first side and a second side;
a tongue/dimple interface on the second side of the tongue, at which a dimple of a loadbeam is movably connected; and
a layer of diamond-like carbon formed on t at least a portion of the tongue at the tongue/dimple interface.

2. The gimbal assembly of claim 1, wherein the dimple is formed from stainless steel.

3. The gimbal assembly of claim 1, wherein the layer of diamond-like carbon is has a thickness of between approximately 10 to 500 nanometers (nm).

4. The gimbal assembly of claim 3, wherein the layer of diamond-like carbon is approximately 10 nm.

5. The gimbal assembly of claim 1, wherein the tongue is formed from stainless steel.

6. The gimbal assembly of claim 3, wherein the diamond-like carbon is formed on only a portion of the tongue at the tongue/dimple interface.

7. The gimbal assembly of claim 4, wherein the diamond-like carbon is formed on only a portion of the tongue at the tongue/dimple interface.

8. The gimbal assembly of claim 3, wherein the diamond-like carbon is formed on the entire portion of the tongue.

9. The gimbal assembly of claim 4, wherein the diamond-like carbon is formed on the entire portion of the tongue.

10. A gimbal assembly of a actuator comprising:
a tongue with a first side and a second side;
a tongue/dimple interface on the second side of the tongue, at which a dimple of a loadbeam is movably connected; and
a layer of diamond-like carbon formed on the dimple.

11. The gimbal assembly of claim 10, wherein the dimple is formed from stainless steel.

12. The gimbal assembly of claim 10, wherein the layer of diamond-like carbon is has a thickness of between approximately 10 to 500 nanometers (nm).

13. The gimbal assembly of claim 12, wherein the layer of diamond-like carbon is approximately 10 nm.

14. The gimbal assembly of claim 10, wherein the tongue is formed from stainless steel.

15. A method of fabricating a flexure assembly of a single or dual stage actuator, comprising:
providing a tongue with a first side and a second side;
providing a loadbeam with a dimple, a tongue/dimple interface being located on the second side of the tongue, at which the dimple is movably connected; and
forming a layer of diamond-like carbon formed on one of: (i) the tongue at the tongue/dimple interface and (ii) the dimple.

16. The method according to claim 15, wherein the layer of diamond-like carbon is between approximately 10 nm and 500 nm in thickness.

17. The method according to claim 16, wherein the diamond-like carbon is approximately 10 nm in thickness.

18. The method according to claim 17, wherein the diamond-like carbon is formed on at least a portion of the tongue at the tongue/dimple interface.

19. The method according to claim 18, wherein the diamond-like carbon is formed on only on a portion of the tongue at the tongue/dimple interface by sputtering with a mask

20. The method according to claim 17, wherein the diamond-like carbon is formed on the dimple.
